(19) United States
(12) Patent Application Publication
(10) Pub. No.: US 2018/0341287 A1
(43) Pub. Date: Nov. 29, 2018

(54) VIDEO BOOK WITH AUTOMATICALLY CHANGING VIDEOS

(71) Applicant: Richard Weber, Downingtown, PA (US)

(72) Inventor: Richard Weber, Downingtown, PA (US)

(21) Appl. No.: 16/054,770

(22) Filed: Aug. 3, 2018

Related U.S. Application Data
(60) Provisional application No. 62/678,128, filed on May 30, 2018.

(51) Int. Cl. G06F 1/16; G06F 3/0483

(52) U.S. Cl. CPC G06F 1/1616; G06F 1/1677; G06F 3/0483

(57) ABSTRACT

A video book offers the user a number of features that maximize the video book and brochure experience through efficient design and ease-of-use. These features include using Hall effect sensors, magnetic reed switches, slide-tongue switches, or other electronic, magnetic or mechanical switches and sensors and the appropriate software to provide synchronization between viewing of the video and printed text and graphics. Tabs may be provided for ease of turning the pages between sections including means to protect the tabs, efficient transmission of the audio output, and soft cover (brochure) and hard cover (book) versions. Embodiments show how these features can be configured into highly effective marketing and communications products. The features can be combined in any number of combinations to satisfy demand for a compelling communications medium.

### CROSS REFERENCE TO RELATED APPLICATIONS

This application claims the benefit of priority to U.S. provisional patent application No. 62/678,128, filed May 30, 2018, the contents of which are herein incorporated by reference.

### BACKGROUND OF THE INVENTION

### 1. Field of the Invention

Embodiments of the invention relates generally to video books. More particularly, the invention relates to video books having automatically changing videos.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Video books or video brochures are regular paper brochures that have working video screens, speakers, printed circuit boards, and rechargeable lithium-ion batteries, integrated into the paper. These products provide an effective and high-impacting way to educate, advertise, or promote a wide range of products and services. If more than one video is included in a typical video book, the videos can be accessed by utilizing a separate button for each video, or by utilizing a “Next” and “Previous” button.

In view of the foregoing, there is a need for a video book that can automatically change videos.

### SUMMARY OF THE INVENTION

Embodiments of the current invention can automatically change the video of a video book by, for example, simply turning the pages. This design also provides more room for photos, illustrations, charts, and text on each spread, which matches the video being played.

The present invention provides the user a number of features that maximize the video book and brochure experience through efficient design and ease of use. These features include: mechanical, magnetic, electronic, tongue and Hall effect sensors for synchronization between viewing of the video and printed text and graphics, tabs for ease of turning the pages between sections including means to protect the tabs, efficient transmission of the audio output, system controls that preserve valuable space for text and graphics also, hard and soft covers to satisfy the brochure and book markets respectively.

Four embodiments show how these features can be configured into very effective communications products. The first embodiment is a brochure with a screen and speaker mounted behind a soft cover. The screen and speaker can be turned on and off by opening and closing the cover activating a low-cost sensor. The sound from the speaker is efficiently transmitted and preserves space for graphics and text. The second embodiment has brochure sections, each section divided by a tab connected to a position sensor that synchronizes the video with the text and graphics of three pages. The tabs extend beyond the outer edge of the front and back cover of the book. Further the embodiment includes manual video and audio control switches that preserve space on the brochure pages for text and graphics. The third embodiment incorporates all of the features of the previous embodiments in addition to an extension of the back cover extending beyond the tips of the tabs. The fourth embodiment incorporates all of the features of the previous embodiments in addition to a hard, front cover and the edge of both covers extending beyond the tips of the tabs.

The features of the present invention can be combined in any number of combinations to satisfy demand for a compelling communications medium.

Embodiments of the present invention provide a method of operation of a video book, comprising automatically altering a video content on a video screen of the video book from a first video content to a second video content when a page of the video book is turned from a first position to a second position.

Embodiments of the present invention further provide a video book comprising one or more pages; a video screen; one or more sensors attached to the one or more pages for sensing a position of each of the one or more pages; and software to automatically control showing a video content on the video screen corresponding to at least one of a text and a graphics on a specific page of the one or more pages.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is a plan view of a video book according to an exemplary embodiment of the present invention with the cover closed;

FIG. 2 is a plan view of the video book of FIG. 1 with the cover open;

FIG. 3 is a perspective view of the video book of FIG. 1 with the cover open and the pages fanned out;

FIG. 4 is a block diagram of the operation of the video book of FIG. 1;

FIG. 5 is a plan view of a video book according to an exemplary embodiment of the present invention with the cover closed;

FIG. 6 is a plan view of the video book of FIG. 5 with the cover open;

FIG. 7 is a perspective view of the video book of FIG. 5 with the cover open and the pages fanned out;

FIG. 8 is a block diagram of the operation of the video book of FIG. 5;

FIG. 9 is a plan view of a video book according to an exemplary embodiment of the present invention with the cover closed;

FIG. 10 is a plan view of the video book of FIG. 9 with the cover open;

FIG. 11 is a perspective view of the video book of FIG. 9 with the cover open and the pages fanned out;

FIG. 12 is a block diagram of the operation of the video book of FIG. 9;

FIG. 13 is a plan view of a video book according to an exemplary embodiment of the present invention with the cover closed;

FIG. 14 is a plan view of the video book of FIG. 13 with the cover open;

FIG. 15 is a perspective view of the video book of FIG. 13 with the cover open and the pages fanned out;

FIG. 16 is a block diagram of the operation of the video book of FIG. 13;

FIG. 17 is a chart summarizing the features of various exemplary embodiments of the present invention;

FIG. 18 is a functional block diagram for the for the electronics of any of the exemplary embodiments of the present invention;

FIG. 19 is an electrical block diagram for the for the electronics of any of the exemplary embodiments of the present invention; and

FIG. 20 is process description block diagram of any of the exemplary embodiments of the present invention.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any apparatus, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a video book which offers the user a number of features that maximize the video book and brochure experience through efficient design and ease-of-use. These features include: using Hall effect sensors, magnetic reed switches, slide-tongue switches, or other electronic, magnetic or mechanical switches and sensors and the appropriate software to provide synchronization between viewing of the video and printed text and graphics. The invention also describes tabs for ease of turning the pages between sections including means to protect the tabs, efficient transmission of the audio output, and soft cover (brochure) and hard cover (book) versions. Four embodiments show how these features can be configured into highly effective marketing and communications products. The features of the present invention can be combined in any number of combinations to satisfy demand for a compelling communications medium.

Embodiments of the present invention provide the ability for the user to browse the contents of a multi-page video brochure or book, and as the user turns each page, the video automatically changes to the appropriate video for the new spread that the user sees. The difference between a book and a brochure is that a book has a hard cover while a brochure has a soft cover. The word “book” will be used throughout the present application to mean “book or brochure”.

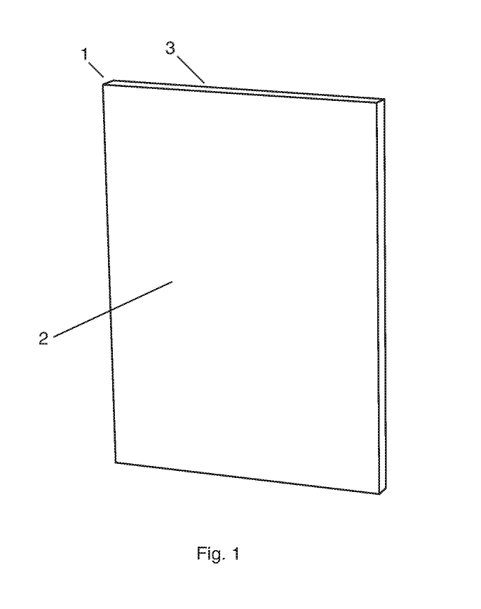

FIG. 1 is a front view of a video book 1 according to a first embodiment of the present invention. Front cover 2 is shown in a closed position and provides a space to introduce the content of the book 3 in graphics and text.

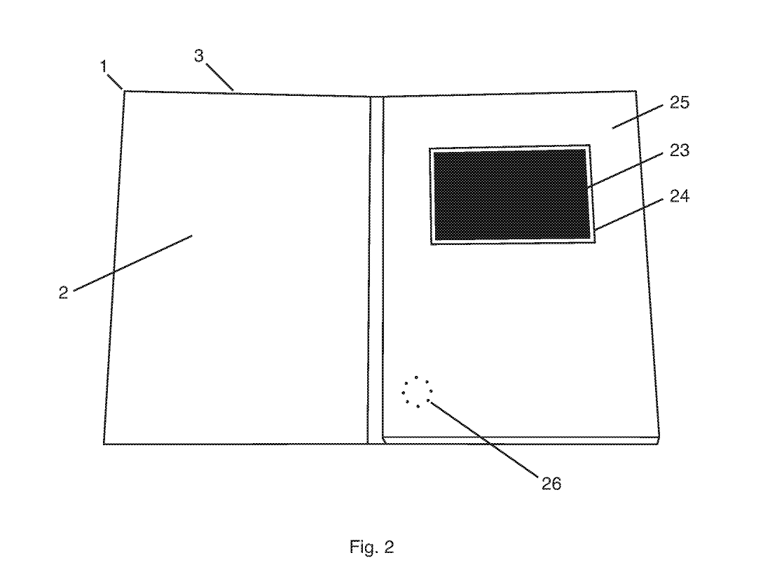

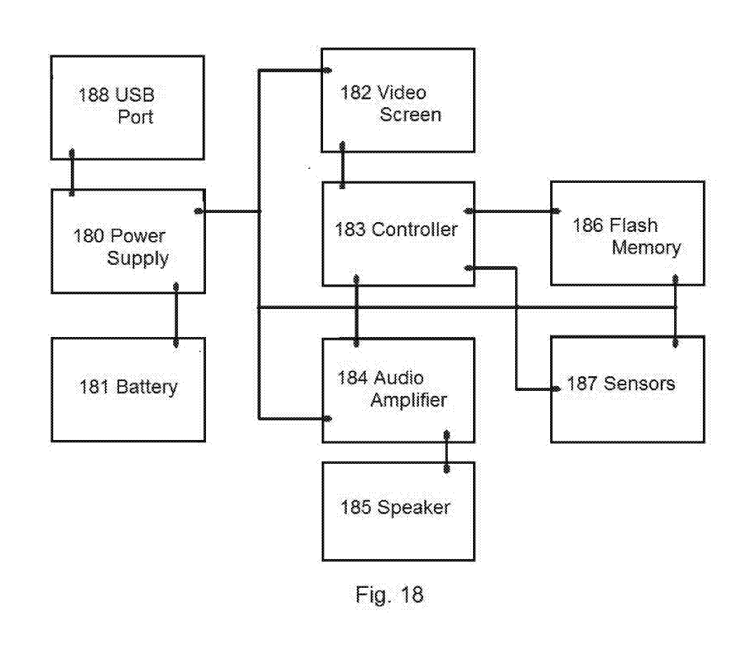

FIG. 2 is a plan view of the video book 1 according to the first embodiment of the present invention in an open position. Rib 21 connects front cover 2 with back cover 25 of book 3. A video screen 23 is mounted on back cover 25. Back cover 25 includes a housing that contains the battery, electronics and controls (FIGS. 18-20) that store and play the video contents (not shown) on the video screen 23 when the book 3 is opened. Video screen 23 can be seen through opening 24 in front intermediate page 22. Speaker access holes 26 allow the sound from the speaker (not shown) to be heard without blockage by the front intermediate page 22.

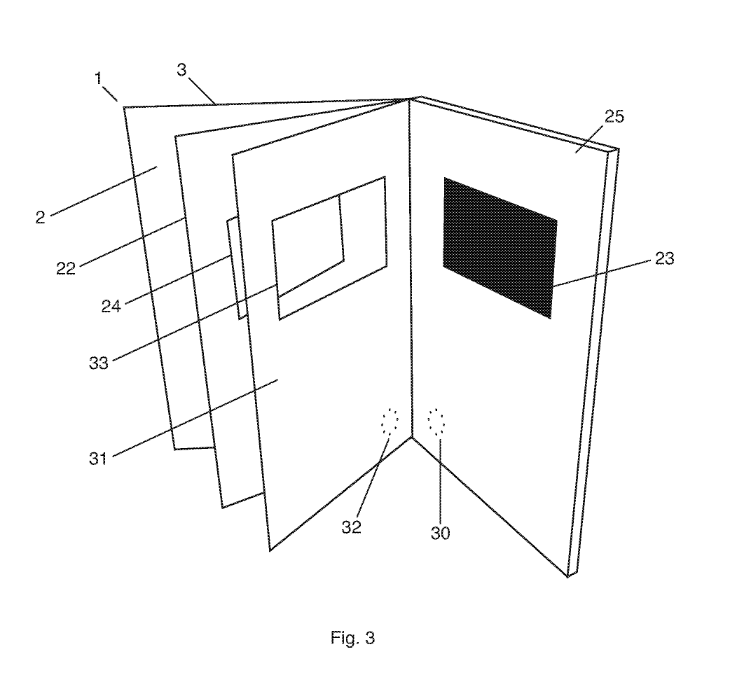

FIG. 3 is a perspective view of the video book according to the first embodiment of the present invention. Book 3 has a front cover 2, intermediate pages 22 and 31, as well as back cover 25, that provide the opportunity to present content in graphics and text (not shown). Openings 33 and 24 provide for un-blocked visibility of the video screen 23. Speaker access holes 30 and 32 allow the sound of the speaker (not shown) to be heard without blockage by the intermediate pages 31 and 22.

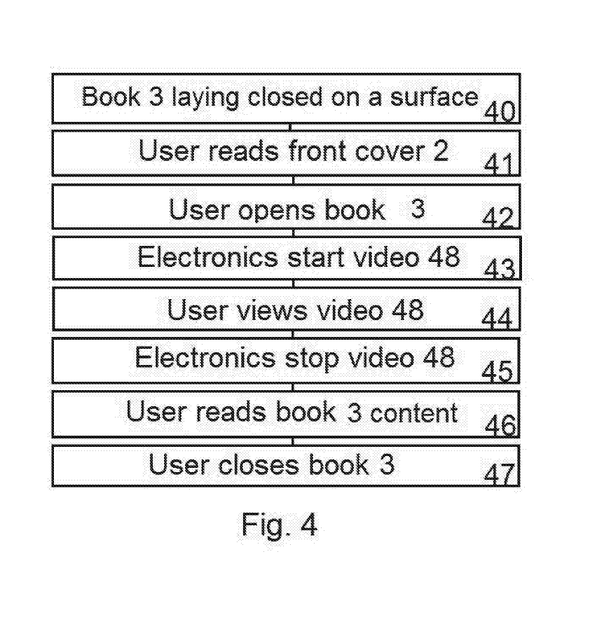

FIG. 4 is a block diagram of the operation of the first embodiment of the present invention. The operation of the book 3 starts by laying closed on a surface (not shown) at 40. The user reads the graphics and or text (not shown) on the front cover at 41. The user opens the cover 2 of the book 3 at 42. A sensor (not shown) in the electronics (FIGS. 18-20) senses the position of the front cover 2 and turns on the video 48 (not shown) at 43 causing video screen 23 to play video 48 (not shown). The user views the video 48 (not shown) at 44. The electronics (FIG. 18-20) stop the video 48 at 45. The user can now read the graphics and text (not shown) on the inside of the book 3 at 46. When the user is finished reading the contents of the graphics and text (not shown) they close the book 3 at 47.

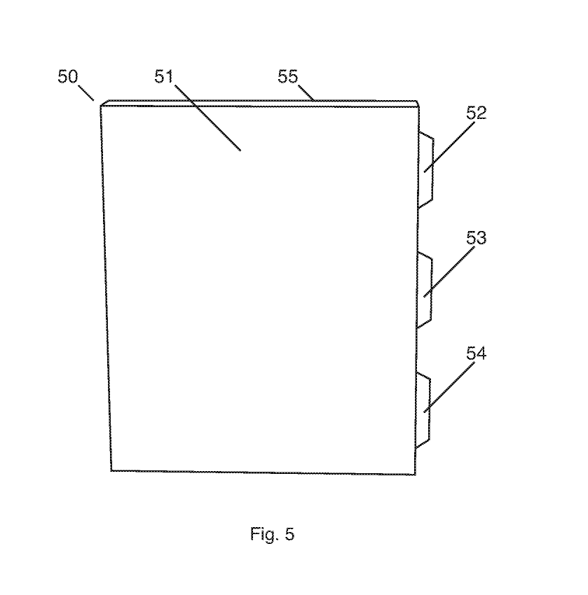

FIG. 5 is a front view of a video book 50 according to a second embodiment of the present invention. Front cover 51 is shown in a closed position and provides a space to introduce the subject of the content (not shown) of the book 55 in text and graphics (not shown). Front tab 52 center tab 53 and back tab 54 provide an easy way for the user to turn the intermediate pages (not shown) of the book 55. Tab 52, tab 53 and tab 54 protrude beyond both front cover 51 and the back cover (not shown).

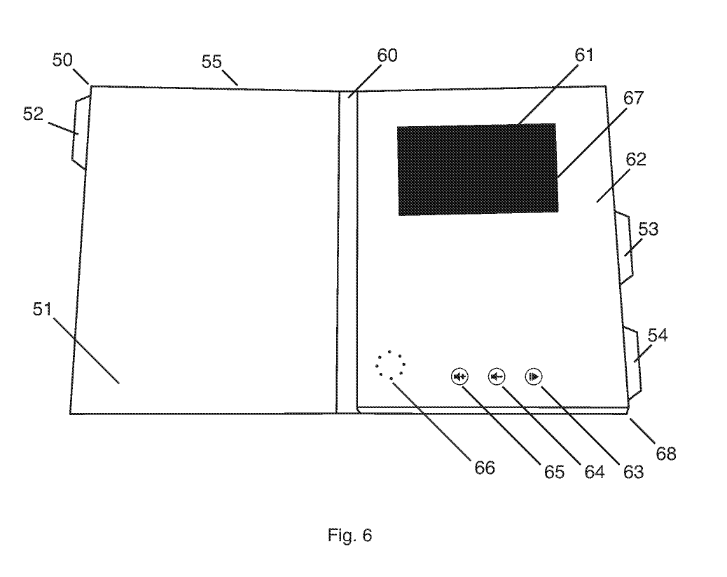

FIG. 6 is a plan view of the second embodiment of the present invention in an open position. Rib 60 connects front cover 51 with back cover 68 of book 55. A video screen 61 shows through opening 67 in front intermediate page 62. Back cover 68 includes a container that holds the battery, electronics and controls (FIGS. 18-20) that store and play the video contents (not shown) on the video screen 61 when the book 55 is opened via tab 52. Button graphic 63 is pressed by the user to increase the volume of the speaker (not shown). Second button graphic 64 is pressed by the user to decrease the volume of the speaker (not shown). Third button graphic 65 is pressed by the user to pause and resume the video 820 (not shown). The electronic buttons (not shown) are located underneath the back intermediate page (not shown). Button graphics are printed on top of the front intermediate page 62 to show the user where the buttons (not shown) are located. The user presses the button graphics (63, 64 and 65) which bends the front intermediate page 62 thereby activating the associated button (not shown). The speaker access holes 66 allow the sound from the speaker (not shown) to be heard. Tabs 53 and 54 provide an easy way for the user to access the remainder of the book 55.

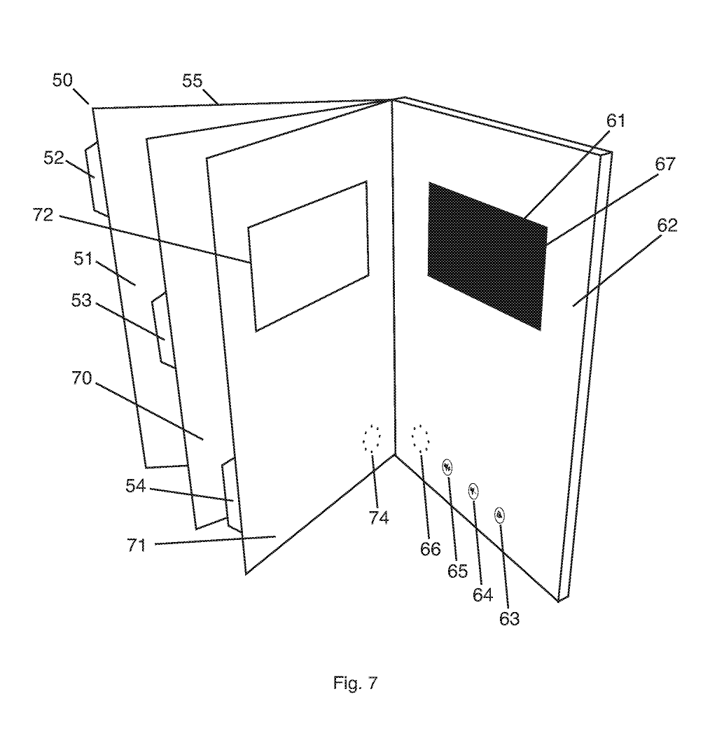

FIG. 7 is a perspective view of the second embodiment of the present invention. Front cover 51 of book 55, intermediate pages 70 and 71, as well as back cover 62, provide the opportunity to present content (not shown) in graphics and text (not shown). Tabs 52, 53, and 54 allow the user an easy way to turn pages 51, 70 and 71 respectively. Openings 72 and 73 provide for un-blocked visibility of the video screen 61. Button 75 allows the user to increase the audio volume. Button 76 allows the user to decrease the audio volume. Button 77 allows the user to pause and restart the video. Speaker access holes 66 and 74 allow the sound of the speaker (not shown) to be heard.

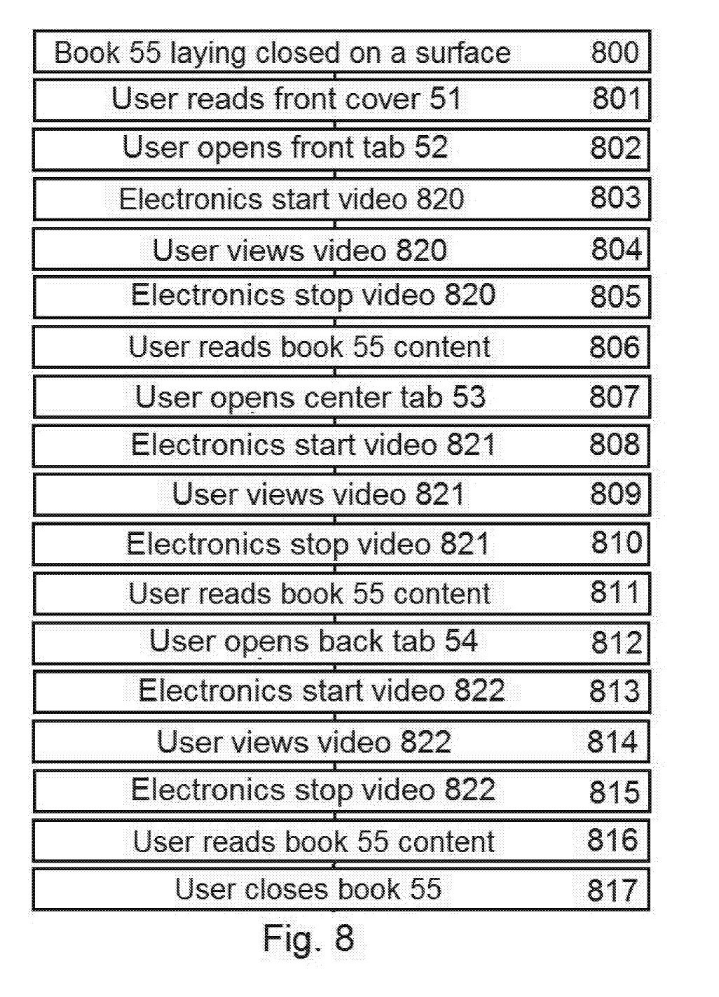

FIG. 8 is a block diagram of the operation of the second embodiment of the present invention. The operation of the book 55 starts by laying closed on a surface (not shown) at 800. The user reads the graphics and text (not shown) on the front cover 51 at 801. The user opens the front tab 52 of the book 55 at 802. A sensor (not shown) in the electronics (FIGS. 18-20) senses the open position of the book cover 51 and turns on the video 820 (not shown) at 803 causing video screen 61 to start video 820 (not shown). The user views the video 820 (not shown) at 804. The electronics (FIGS. 18-20) stops the video 820 (not shown) at 805. The user can now read the text and/or graphics (not shown) on the inside of the book at 806. The next thing that happens is the user opens center tab 53 at 807. The electronics (FIGS. 18-20) starts video 821 (not shown) at 808. The user views the video 821 (not shown) at 809. The electronics (FIGS. 18-20) stops video 821 (not shown) at 810. Next, the user reads the text and/or graphics (not shown) of the book 55 at 811. This is followed by user opening tab 54 at 812. Then the electronics (FIGS. 18-20) starts video 822 (not shown) at 813. Next the user views the video 822 (not shown) at 814. Now the electronics (FIGS. 18-20) stops the video 822 (not shown) at 815. Followed by the user reading the book 55 content (not shown) at 816. Finally, the user closes the book 55 at 817.

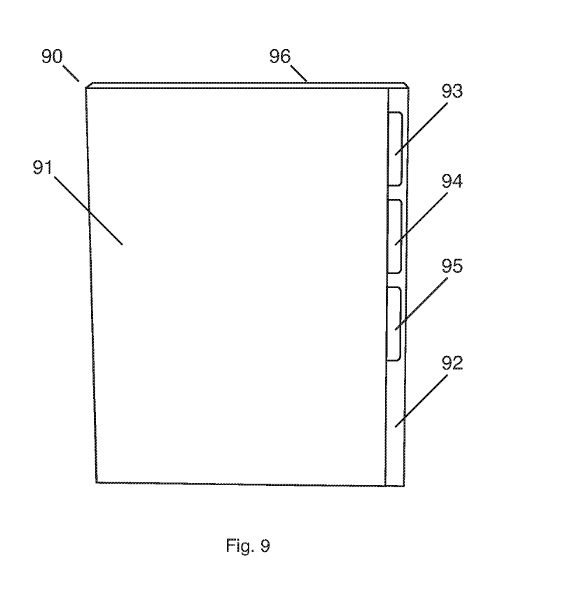

FIG. 9 is a front view of a video book 90 according to a third embodiment of the present invention. Front cover 91 of book 96 is shown in a closed position and provides a space to introduce the subject of the content (not shown) of the book 96 in text and/or graphics (not shown). Front tab 93, center tab 94 and back tab 95 provide an easy way for users to turn to the intermediate pages (not shown). Tab 93, tab 94 and tab 5 protrude beyond the front cover 91. The back cover 97 protrudes beyond the tab 93, tab 94 and tab 95.

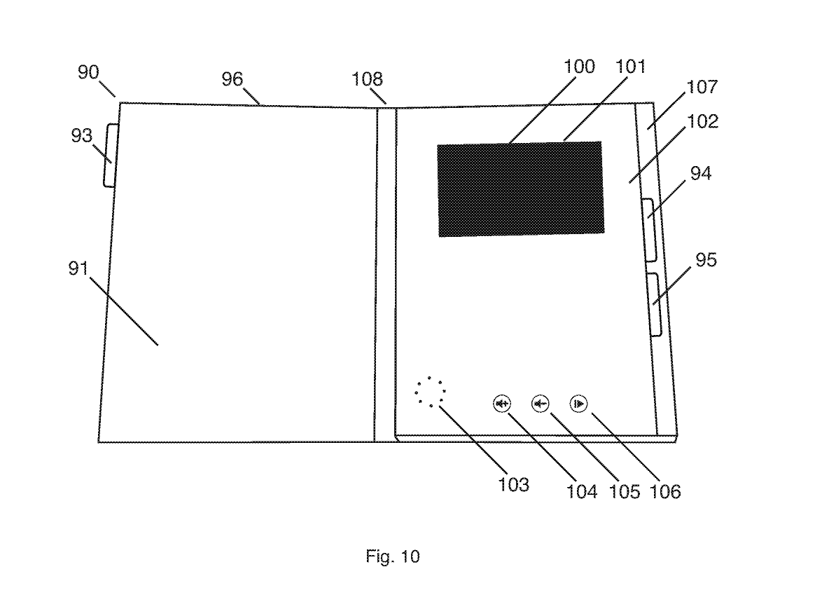

FIG. 10 is a plan view of the third embodiment of the present invention in an open position. Rib 108 connects front cover 91 with back cover 107 of book 96. A video screen 100 shows through opening 101 in front page 102. Back cover 107 includes a container that holds the battery, speaker, buttons, etc. (FIGS. 18-20) that store and play the video contents on the video screen 100 when the book 96 is opened via tab 93. Video screen 100 can be seen through opening 101 in first intermediate page 102. Button graphic 106 is pressed by the user to increase the volume of the speaker (not shown). Button graphic 105 is pressed by the user to decrease the volume of the speaker (not shown). Button graphic 104 is pressed by the user to pause and resume the video 820. The user presses the button graphics (104, 105 and 106) which bends the front intermediate page 102 thereby activating the associated button (not shown). Speaker access holes 103 allow the sound from the speaker (not shown) to be heard. Also, shown are tab 94 for opening the book 90 to the center intermediate page (not shown) and tab 95 for opening the book 96 to the back intermediate page 107.

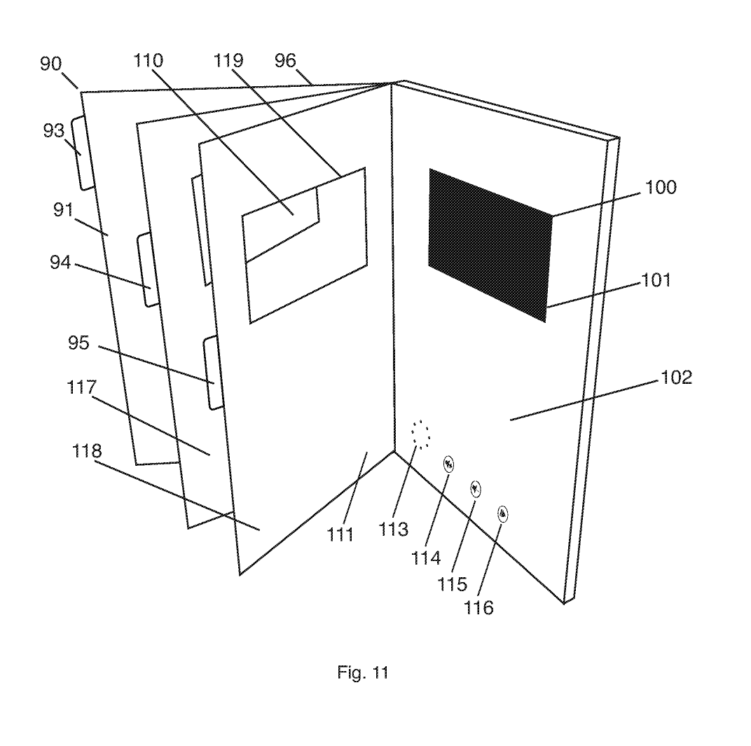

FIG. 11 is a perspective view of the third embodiment of the present invention. Front cover 91, intermediate pages 117 and 118 as well as back cover 102 of book 96 provide the opportunity to present content (not shown) in text and/or graphics (not shown). Tabs 93, 94 and 95 allow the user an easy way to turn pages 91, 117 and 118 respectively. Openings 110 and 101 provide for un-blocked visibility of the video screen 100. Button 116 is pressed by the user to increase the volume of the speaker (not shown). Button 115 is pressed by the user to decrease the volume of the speaker (not shown). Button 114 is pressed by the user to pause and resume the video 820. Pattern of speaker access holes 111 and 113 allow the sound of the speaker (not shown) to be heard.

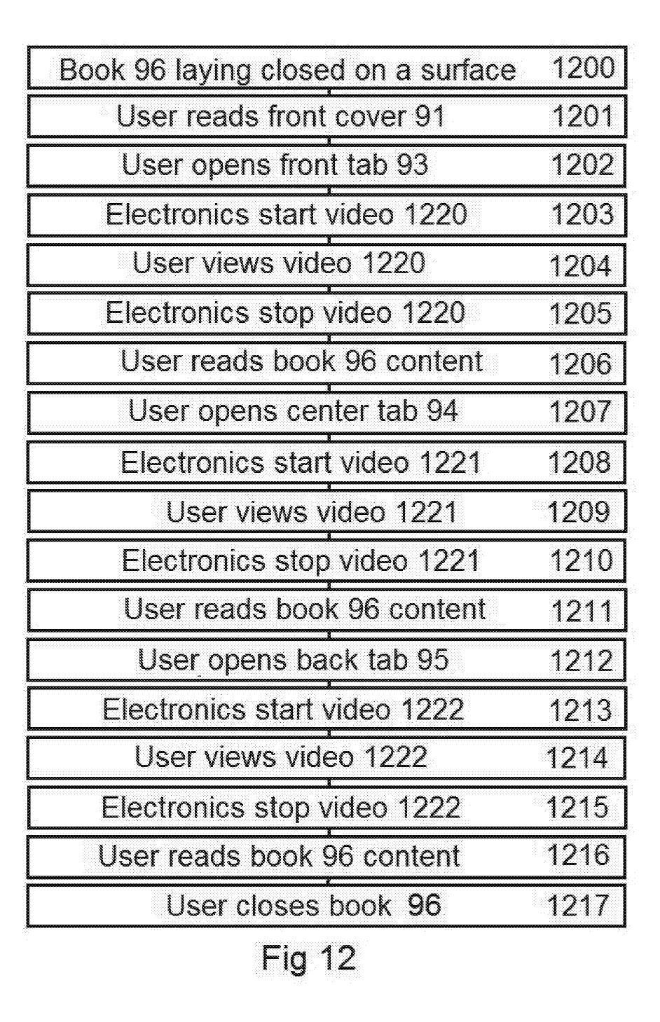

FIG. 12 is a block diagram of the operation of the third embodiment of the present invention. The operation of the book 96 starts by laying closed on a surface (not shown) at 1200. The user reads the text and/or graphics (not shown) on the front cover at 1201. The user opens the front tab 93 of the book 96 at 1202. A sensor (not shown) in the electronics (FIGS. 18-20) senses the position of the cover 91 and turns on the video 1220 (not shown) at 1203 causing video screen 100 to play video 1220 (not shown). The user views the video 1220 (not shown) at 804. The electronics (FIGS. 18-20) stops the video 1220 at 1205. The user can now read the text and/or graphics (not shown) on the inside of the book 96 at 1206. The next thing that happens is the user opens center tab 94 at 1207. The electronics (FIGS. 18-20) starts video 1221 (not shown) at 808. The user views the video 1221 (not shown) at 1209. The electronics (FIGS. 18-20) stops video 1221 (not shown) at 1210. Next, the user reads the text and/or graphics (not shown) of the book 96 at 1211. This is followed by user opening back tab 95 at 1212. Then the electronics (FIG. 18-20) starts video 1222 (not shown) at 1213. Next the user views the video 1222 (not shown) at 1214. Now the electronics (FIG. 18-20) stops the video 1222 (not shown) at 1215 followed by the user reading the book 90 contents (not shown) at 1216. Finally, the user closes the book 96 at 1217.

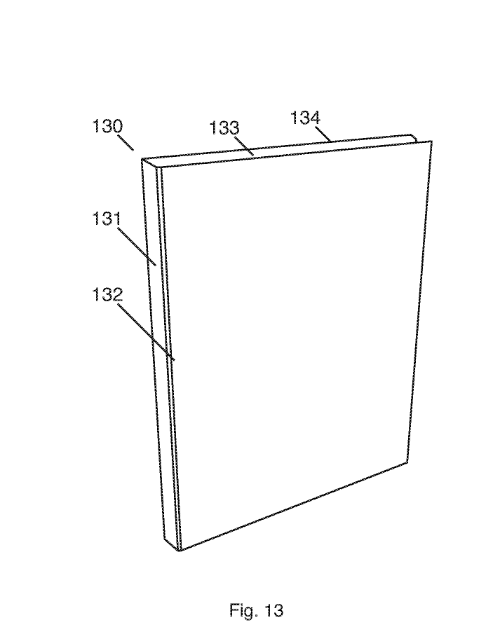

FIG. 13 is a front view of a video book 130 according to a fourth embodiment of the present invention. Front cover 132 is shown in a closed position and provides a space to introduce the subject of the content (not shown) of the book 134 in text and/or graphics (not shown). Rib 131 connects front cover 132 with back cover 133.

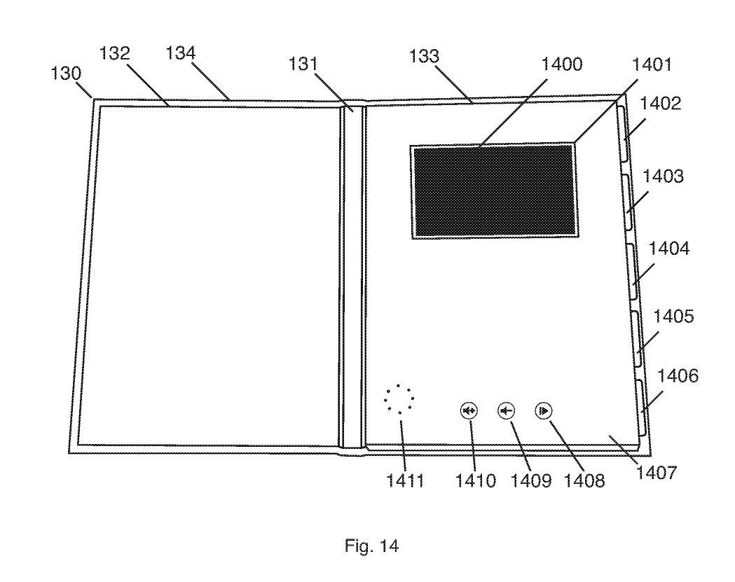

FIG. 14 is a plan view of the forth embodiment of the present invention in an open position. Rib 131 of book 134 connects front cover 132 with back cover 133. Front cover 132 and back cover 133 protrude beyond tab 1402, tab 1403, tab 1404, tab 1405 and tab 1406 when the book 134 is closed as in FIG. 13. A video screen 1400 shows through opening 1401 in front intermediate page 1407. Back cover 133 includes a container that holds the, battery, speaker, buttons, etc. (FIGS. 18-20) that store and play the video 1420 contents (not shown) on the video screen 1400 when the book 134 is opened. Button graphic 1408 is pressed by the user to increase the volume of the speaker (not shown). Button graphic 1409 is pressed by the user to decrease the volume of the speaker (not shown). Button graphic 1410 is pressed by the user to pause and resume the video 1420 (not shown). Speaker access holes 1411 allow the sound from the speaker (not shown) to be heard. Also, shown are tab 1402 for opening the book 134 to the front intermediate page (not shown) and tabs 1403, 1404, 1405 and 1406 for opening the book 134 to the additional intermediate pages (not shown).

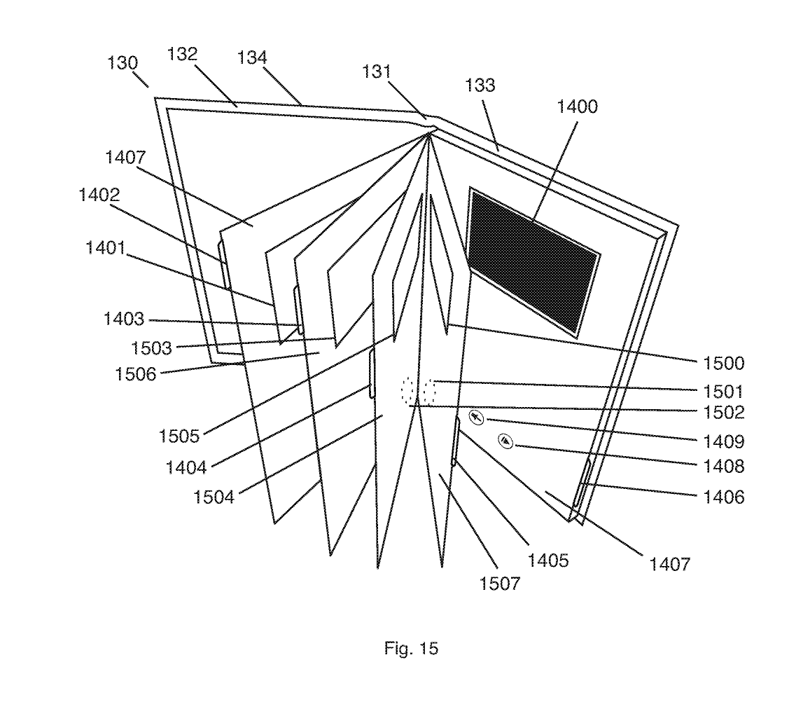

FIG. 15 is a perspective view of the fourth embodiment of the present invention in the open position. Rib 131 connects front cover 132 with back cover 133. Front cover 132 of book 134, intermediate pages 1407, 1506, 1504 and 1507 as well as back cover 133, provide the opportunity to present content (not shown) in text and/or graphics (not shown). Tabs 1402, 1403, 1404, 1405 and 1406 allow the user an easy way to turn pages 1407, 1506, 1504 and 1507. Openings 1401, 1503, 1595 and 1500 provide for un-blocked visibility of the video screen 1400. Speaker access holes 1501 and 1502 as well as similar openings in pages 1506, and 1407 (not shown) allow the sound of the speaker (not shown) to be heard. Button 1408 allows the user to increase the volume of the audio (FIG. 18-20). Button 1409 allows the user to decrease the volume of the audio (FIGS. 18-20).

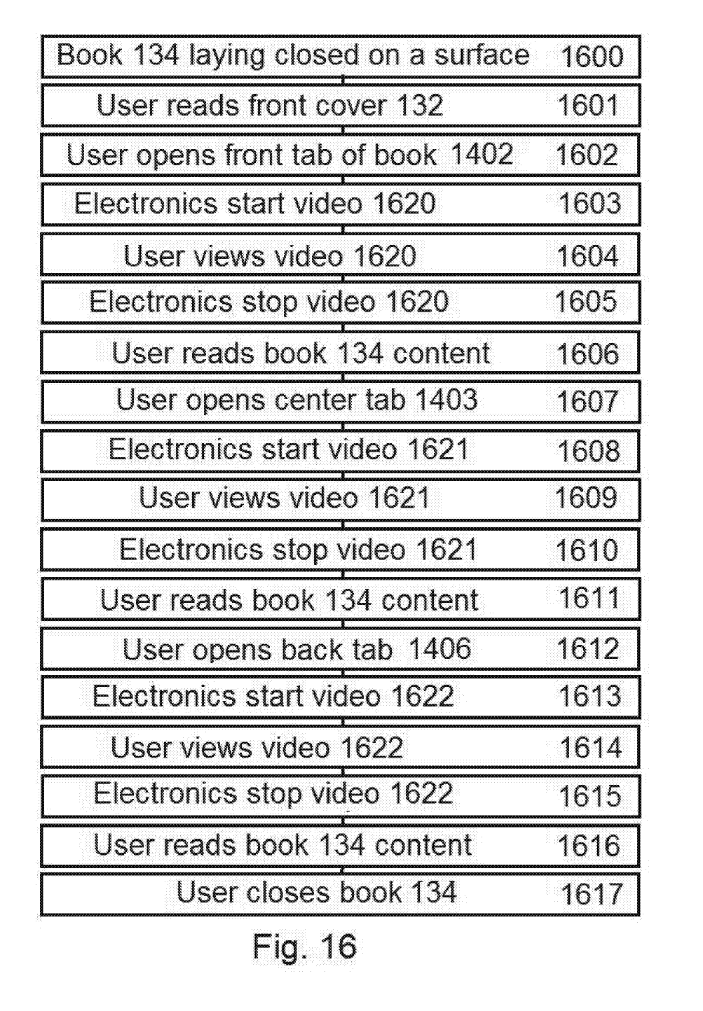

FIG. 16 is a block diagram of the operation of the fourth embodiment of the present invention. The operation of the book 134 starts by laying closed on a surface (not shown) at 1600. The user reads the text and/or graphics (not shown) on the front cover 132 at 1601. The user opens the front tab 1402 of the book 134 at 1602. A sensor (not shown) in the electronics (FIGS. 18-20) senses the position of the cover 132 and turns on the video 1620 (not shown) at 1603 causing video screen 1400 to play video 1620 (not shown). The user views the video 1620 (not shown) at 1604. The electronics (FIGS. 18-20) stops the video 1620 (not shown) at 1605. The user can now read the text and/or graphics (not shown) on the inside of the book 134 at 1606. The next thing that happens is the user opens center tab 1403 at 1607. The electronics (FIGS. 18-20) starts video 1621 (not shown) at 1608. The user views the video 1621 (not shown) at 1609. The electronics (FIGS. 18-20) stops video 1621 (not shown) at 1610. Next, the user reads the text and/or graphics (not shown) of the book 134 at 1611. To avoid redundancy the operations involving tabs 1404 and 1405 are (not shown). This is followed by user opening back tab 1406 at 1612. Then the electronics (FIGS. 18-20) starts video 1622 (not shown) at 1613. Next the user views the video 1622 (not shown) at 1614. Now the electronics (FIGS. 18-20) stops the video 1622 (not shown) at 1215. Followed by the user reading the book 134 contents (not shown) at 1616. Finally, the user closes the book 134 at 1617.

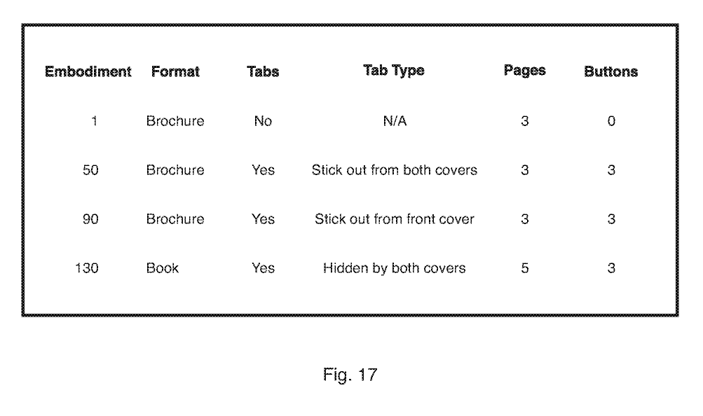

FIG. 17 is a chart comparing the major features of the four embodiments of the present invention.

FIG. 18 is a functional block diagram of the electronics for any of the four embodiments of the present invention. Power supply 180 converts the 3.7-volt power from the USB port 188, converts the required level, regulates it and outputs it to the battery 181. Battery 181 may be a lithium-ion battery that stores the power for the remainder of the device operation until needed. The video screen 182 requires power. The main controller 183 takes digital signals from the flash memory 186 and outputs them to the video screen 182. The controller 183 also outputs audio signals to the audio amplifier 184. After amplification the output from the audio amplifier 184 is connected to the input of the speaker 185 where it is converted into sound waves. The flash memory 186 (requires no power when not in use) stores the digital video and audio signals until called for by the sensors 187 that employ Hall effect or magnetic technology and are activated by the movement of the front cover (not shown) and intermediate pages (not shown) of the book (not shown).

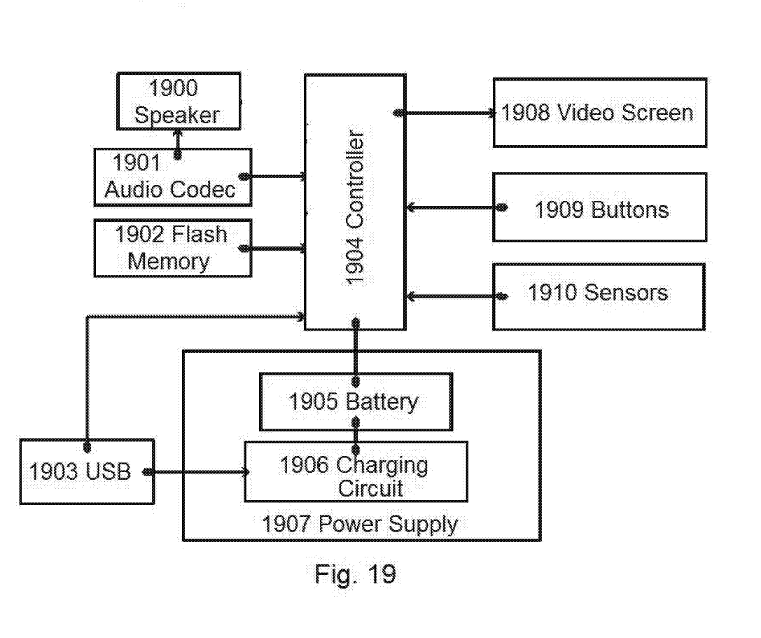

FIG. 19 is an electrical block diagram of the electronics for any of the four embodiments of the present invention. Charging circuit 1906 charges the battery 1905 with power input from the USB port 1903. Controller 1904 oversees the operation of all of the components. Video screen 1908 inputs video signals from the controller 1904. Buttons 1909 provide the direct inputs from the user such as volume up and down, pause the video and resume the video. The 1910 determine the position of the tabs for control of the video. The flash memory 1902 stores the digital audio and video information for playback by the video screen 1908. The audio codec 1901 controls the digital output of the controller 1904 and outputs analog output to the speaker 1900.

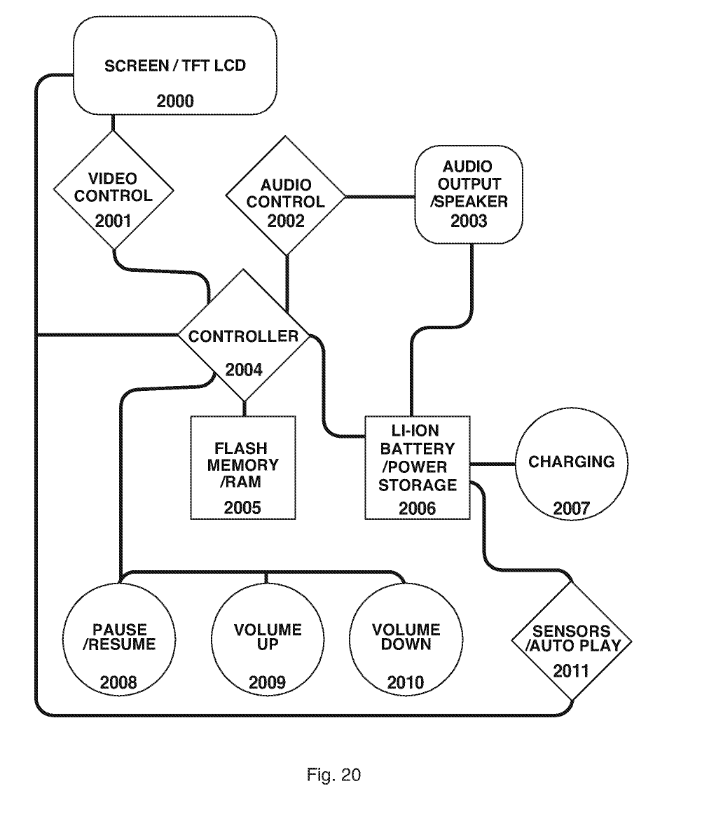

FIG. 20 is the process description block diagram of any of the four embodiments of the present invention. A circular block denotes an input process. A rectangular block denotes a storage or passive process. A diamond shape block denotes a control process. An oblong block denotes an output process. A thick black line denotes a process linkage. Video screen 2000 is a human interface to visualize the stored data in the flash memory 2005. Video Control 2001 is the electronic circuitry to process the video stored in flash memory 2005. Audio control 2002 is the electronic circuitry to process the audio stored in the flash memory 2005. The speaker 2003 is a human interface to hear the stored data in the flash memory 2005. Controller 2004 is the brain of the system that processes the data and actuates instructions. Flash memory 2005 is a random access memory that stores the video data associated with each tab (see the figures associated with each embodiment to identify the tab reference numbers for each embodiment) and controlled by sensors 2011. Battery 2006 is to power up passive component systems. Charger 2007 is a USB port to recharge the battery and change the videos (see the block diagrams associated with each embodiment to identify the reference numbers of the videos associated with each embodiment) stored in the flash memory 2005. Pause/resume 2008 is a switch used to control the pausing and resuming of the video. Volume up 2009 is a switch used to control increasing the audio volume to the speaker 2003. Volume down 2010 is a switch used to control decreasing of the audio volume to the speaker 2003. Sensors sense the position of the tabs (see the features of each embodiment for the drawing reference numbers associated with each tab) and indicate to the controller 2004 which video to be output to the video control 2001.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A method of operation of a video book, comprising:
automatically altering a video content on a video screen of the video book from a first video content to a second video content when a page of the video book is turned from a first position to a second position.

2. The method of claim 1, further comprising automatically returning the video content to the first video content when the page is returned to the first position from the second position.

3. A video book comprising:
one or more pages;
a video screen;
one or more sensors attached to the one or more pages for sensing a position of each of the one or more pages; and
software to automatically control showing a video content on the video screen corresponding to at least one of a text and a graphics on a specific page of the one or more pages.

4. The video book of claim 3, wherein the one or more sensors is a Hall Effect sensor.

5. The video book of claim 3, wherein the one or more sensors is a magnetic reed switch.

6. The video book of claim 3, wherein the one or more sensors is a slide tongue sensor.

7. The video book of claim 3, wherein the one or more sensors is an electronic sensor.

8. The video book of claim 3, wherein the one or more sensors is a magnetic sensor.

9. The video book of claim 3, further comprising tabs on the one or more pages to facilitate turning each page.

10. The video book of claim 9, wherein at least one of text and graphics on each tab identify a corresponding section of the video book.

11. The video book of claim 9, wherein the tabs are shorter than a length of the front and back covers of the book to protect the tabs from damage.

12. The video book of claim 9, wherein the tabs are longer than the length of the front and back covers of the book, making it easy to see the tabs.

13. The video book of claim 9, wherein the tabs are shorter than the length of the back cover and longer than the length of the front cover to provide both protection and visibility of the tabs.

14. The video book of claim 3, further comprising a back cover including a front facing audio speaker, wherein the pages between the speaker and free air contain one or more holes to transmit a sound.

15. The video book of claim 3, further comprising control buttons that are activated through one or more pages by flexure of the one or more pages.

16. The video book of claim 15, wherein the control buttons are disposed on a last one of the pages.

17. The video book of claim 3, further comprising one or more control buttons disposed on a last one of the pages, wherein one or more pages prior to the last one of the pages are shortened to permit access to the one of more control buttons.
